(19) United States
(12) Patent Application Publication
(10) Pub. No.: US 2010/0052572 A1
(43) Pub. Date: Mar. 4, 2010

(54) LIGHT EMITTING ELEMENT DRIVING APPARATUS

(75) Inventors: Shinichiro KATAOKA, Osaka (JP); Ryuji UEDA, Osaka (JP); Go TAKATA, Hyogo (JP); Daisuke ITOU, Osaka (JP); Yasunori YAMAMOTO, Osaka (JP); Tsukasa KAWAHARA, Kyoto (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/548,781

(22) Filed: Aug. 27, 2009

(30) Foreign Application Priority Data
Aug. 28, 2008 (JP) 2008-219869

(51) Int. Cl. H05B 37/02

(52) U.S. Cl. 315/297

(57) ABSTRACT

The N light emitting element groups each include one or more light emitting elements. The power source circuit includes a control input terminal and supplies the power source voltage to the N light emitting element groups. The N current driving circuits, each including a feedback output terminal, generate N drive currents for driving the respective N light emitting element groups and generate main feedback voltages at the feedback output terminals based on the power source voltage. The main feedback circuit applies a main feedback signal to the control input terminal based on the N main feedback voltages. The auxiliary feedback circuit applies an auxiliary feedback signal to the control input terminal based on the power source voltage. The power source circuit adjusts the power source voltage based on at least one of the main feedback signal and the auxiliary feedback signal.

### BACKGROUND OF THE INVENTION

1. Field of Invention

The present invention relates to a driving apparatus for driving light emitting elements, and more particularly, to a light emitting element driving apparatus for driving light emitting elements, such as LEDs (light emitting diodes), by using a DC/DC converter as a voltage source.

2. Description of Related Art

As a conventional light emitting element driving apparatus, a configuration shown in FIG. 6 has been proposed to reduce power loss and enhance efficiency (for example, refer to Japanese Laid-open Patent Publication No. 2007-242477).

In FIG. 6, current driving circuits 101A, 101B and 101C current-drive light emitting element groups 100A, 100B and 100C, respectively. Each of the light emitting element groups 100A, 100B and 100C contains multiple LEDs, and the multiple LEDs are connected in series so that a drive current flows in the forward direction from the anode to the cathode thereof. Furthermore, voltage drop detection circuits 102A, 102B and 102C are connected to the three connection points of the light emitting element groups 100A, 100B and 100C and the current driving circuits 101A, 101B and 101C, respectively. The voltage drop detection circuits 102A, 102B and 102C detect the voltages at the three connection points, respectively, and transmit detection signals to a control signal generating section 106. The control signal generating section 106 specifies one of the light emitting element groups 100A, 100B and 100C, which is generating the largest voltage drop, in other words, which is driven by the largest current. Furthermore, the control signal generating section 106 controls a power conversion section 107 so that the voltage across the terminals of the current driving circuit driving the specified light emitting element group becomes a necessary minimum voltage capable of normally current-driving the light emitting element group.

In other words, the control signal generating section 106 optimizes the voltages at the three connection points using a feedback loop formed by the power conversion section 107, the light emitting element groups 100A, 100B and 100C, and the voltage drop detection circuits 102A, 102B and 102C.

Hence, since all the voltages across the terminals of the current driving circuits 101A, 101B and 101C have become the necessary minimum voltage or more, improper light emission due to insufficient power supply to the current driving circuits can be resolved. At the same time, since the voltages across the terminals of the current driving circuits 101A, 101B and 101C are sufficiently small, wasteful power consumed in the current driving circuits and heat generated therein can be reduced. As a result, highly efficient LED driving can be achieved.

As described above, the conventional light emitting element driving apparatus has a configuration wherein one of the multiple current driving circuits connected in parallel, in which the current flowing therethrough is the largest and in which the voltage at the connection point to the corresponding light emitting element group is the lowest, is specified so that the voltage across the terminals of the specified current driving circuit becomes the necessary minimum voltage.

However, the conventional light emitting element driving apparatus has problems described below.

That is to say, duty control for switching the ratio between the ON period and the OFF period of the drive current from each of the current driving circuits 101A, 101B and 101C is generally performed as a method for adjusting the brightness of each of the light emitting element groups 100A, 100B and 100C. When the duty control is performed, there is a period in which all the current driving circuits 101A, 101B and 101C become OFF.

When all the current driving circuits 101A, 101B and 101C become OFF, the voltages at the connection points of the light emitting element groups 100A, 100B and 100C and the current driving circuits 101A, 101B and 101C, that is, the input voltages of the voltage drop detection circuits 102A, 102B and 102C, become indefinite or significantly different from the voltages obtained during normal operation in which one or more of the current driving circuits are in the ON state. As a result, the above-mentioned feedback loop is substantially cut.

As states in which the feedback loop is cut, two states are mainly conceived, that is, a state in which the output voltage (also referred to as a power source voltage) of the power conversion section 107 (also referred to as a power source circuit) becomes lower than the voltage obtained during normal operation in which one or more of the current driving circuits are in the ON state and a case in which the output voltage becomes higher than the voltage obtained during normal operation.

In the state in which the power source voltage of the power source circuit 107 becomes lower than that obtained during the normal operation when all the current driving circuits 101A, 101B and 101C are OFF, immediately after at least one of the current driving circuits 101A, 101B and 101C is switched from the OFF state to the ON state again, the voltage across the terminals of the current driving circuit having been switched to the ON state becomes smaller than the necessary minimum voltage. Hence, the current driving circuit having been switched to the ON state cannot drive the corresponding one of the light emitting element groups 100A, 100B and 100C. In particular, as the OFF periods of all the current driving circuits 101A, 101B and 101C are longer, the voltages across the terminals of the current driving circuits immediately after the switching become smaller. Hence, accurate duty control cannot be performed.

Furthermore, in the state in which the power source voltage of the power source circuit 107 becomes higher than that obtained during the normal operation when all the current driving circuits 101A, 101B and 101C are OFF, the power source voltage of the power source circuit 107 rises continuously and significantly, and withstand voltage breakdown occurs in the current driving circuits 101A, 101B and 101C. Immediately after at least one of the current driving circuits 101A, 101B and 101C is switched from the OFF state to the ON state again, the voltage across the terminals of the current driving circuit having been switched to the ON state becomes a voltage not less than the necessary minimum voltage, whereby the power loss in the current driving circuit having been switched to the ON state becomes large.

Moreover, in addition to the above-mentioned problems, there are problems in which since the above-mentioned feedback loop is substantially cut when all the current driving circuits 101A, 101B and 101C are in the OFF state, ripples are generated in the power source voltage of the power source circuit 107, whereby the accuracy of the currents for driving the light emitting element groups is degraded and EMI (electro-magnetic interference) increases.

### SUMMARY OF THE INVENTION

In consideration of the problems encountered in the above-mentioned conventional light emitting element driving apparatus, an object of the present invention is to provide a light emitting element driving apparatus capable of supplying a stable power source voltage during duty control. Another object of the present invention is to provide a light emitting element driving apparatus characterized in that current driving circuits contained therein have a high withstand voltage and that circuits connected in parallel with the current driving circuits are prevented from withstand voltage breakdown.

For the purpose of achieving the above-mentioned objects, the light emitting element driving apparatus according to the present invention has N (where N is an integer of 1 or more) light emitting element groups each including one or more light emitting elements; a power source circuit, including a control input terminal, operable to supply a power source voltage to the N light emitting element groups; N current driving circuits, each including a feedback output terminal and operable to generate a drive current for driving one of the N light emitting element groups and to generate a main feedback voltage at the feedback output terminal based on the power source voltage, whereby the N current driving circuits generate N drive currents and N main feedback voltages; a main feedback circuit operable to apply a main feedback signal to the control input terminal based on the N main feedback voltages; and an auxiliary feedback circuit operable to apply an auxiliary feedback signal to the control input terminal based on the power source voltage, wherein the power source circuit adjusts the power source voltage based on at least one of the main feedback signal and the auxiliary feedback signal.

Furthermore, the light emitting element driving apparatus according to the present invention has N (where N is an integer of 1 or more) light emitting element groups each including one or more light emitting elements; a power source circuit, including a control input terminal, operable to supply a power source voltage to the N light emitting element groups; N current driving circuits, each including a feedback output terminal and operable to generate a drive current for driving one of the N light emitting element groups and to generate a feedback voltage at the feedback output terminal based on the power source voltage, whereby the N current driving circuits generate N feedback voltages; and a feedback circuit operable to apply a feedback signal to the control input terminal based on the N feedback voltages, wherein the N current driving circuits each include a transistor and a current source, the feedback output terminal is inserted between the transistor and the current source, and the power source circuit adjusts the power source voltage based on the feedback signal.

In the light emitting element driving apparatus according to the present invention, in the OFF state of the light emitting elements (all the current driving circuits are in the OFF state), since the adjustment operation of the power source circuit is continued using the auxiliary feedback circuit, the power source voltage is stabilized to a predetermined voltage even in the light emitting element OFF state. Hence, in both the light emitting element OFF state and the light emitting element ON state (one or more current driving circuits are in the ON state), even if the period of the light emitting element OFF state becomes long, the width of fluctuations including ripples and the like in the power source voltage V69 can be made sufficiently small. As a result, since the current sources operable to generate the drive currents in the current driving circuits can maintain a voltage sufficient to perform current driving at all times, when the light emitting element OFF state is switched to the light emitting element ON state, the responsiveness of the current driving circuits can be enhanced. Furthermore, since the power source voltage is prevented from rising excessively in the light emitting element OFF state, withstand voltage breakdown is prevented, power consumption is reduced, and EMI is also reduced in the light emitting element driving apparatus. As described above, the light emitting element driving apparatus can perform accurate duty control using the auxiliary feedback circuit.

Furthermore, with the light emitting element driving apparatus according to the present invention, the current driving circuits are each formed of an N-channel MOS transistor and a current source. Hence, by using components having a high withstand voltage as the N-channel MOS transistors and by using components having a low withstand voltage in the circuits connected in parallel between the feedback output terminals and the ground, such as the current sources, the main feedback circuit, the auxiliary feedback circuit, and the input setting circuit, both the high-voltage driving of the light emitting element groups and the use of the low withstand voltage components can be achieved. By using components having a high withstand voltage, the numbers of the light emitting element groups, the N-channel MOS transistors, the current sources, etc. can be reduced. As a result, the power consumption of the light emitting element driving apparatus can be reduced, and the cost thereof can also be reduced. Moreover, by using components having a low withstand voltage, the areas of the semiconductor chips for the circuits are decreased. As a result, the power consumption of the light emitting element driving apparatus can be reduced, and the cost thereof can also be reduced.

### BRIEF DESCRIPTION OF THE DRAWINGS

FIG. 1A is a circuit diagram showing a configuration of a light emitting element driving apparatus according to a first embodiment of the present invention;

FIG. 1B is a timing chart showing the operation of the light emitting element driving apparatus according to the first embodiment of the present invention;

FIG. 2 is a circuit diagram showing a configuration of a light emitting element driving apparatus according to a second embodiment of the present invention;

FIG. 3 is a circuit diagram showing a configuration of a light emitting element driving apparatus according to a third embodiment of the present invention;

FIG. 4 is a circuit diagram showing a configuration of a light emitting element driving apparatus according to a fourth embodiment of the present invention;

FIG. 5 is a circuit diagram showing a configuration of a light emitting element driving apparatus according to a fifth embodiment of the present invention; and

FIG. 6 is a circuit diagram showing a configuration of the conventional light emitting element driving apparatus.

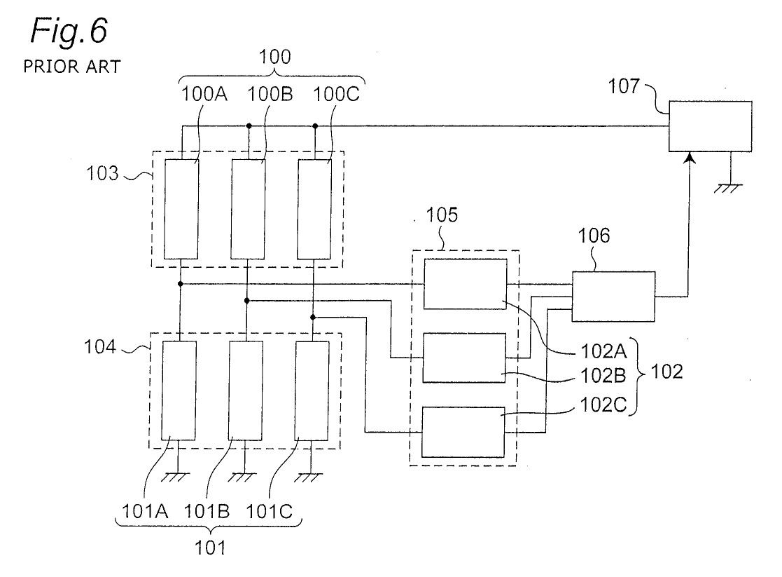

### DETAILED DESCRIPTION OF THE PREFERRED EMBODIMENTS

Some examples of the best modes for embodying the present invention will be described below referring to the accompanying drawings. In the drawings, components having substantially the same configurations, operations and effects are designated by the same reference codes. Numbers described below are all exemplified to specifically explain the present invention, and the present invention is not limited by the exemplified numbers. Furthermore, the logic levels represented by high/low levels or the switching states represented by ON/OFF states are used to specifically exemplify the present invention, and similar results can also be obtained by variously combining exemplified logic levels or switching states. Moreover, connections between the components are exemplified to specifically explain the present invention, and connections for achieving the functions of the present invention are not limited to these connections. Still further, although embodiments described below are configured using hardware and/or software, a configuration implemented by hardware can also be implemented by software, and a configuration implemented by software can also be implemented by hardware.

### 1. First Embodiment

### 1.1 Configuration and Operation

### 1.1.1 General Description

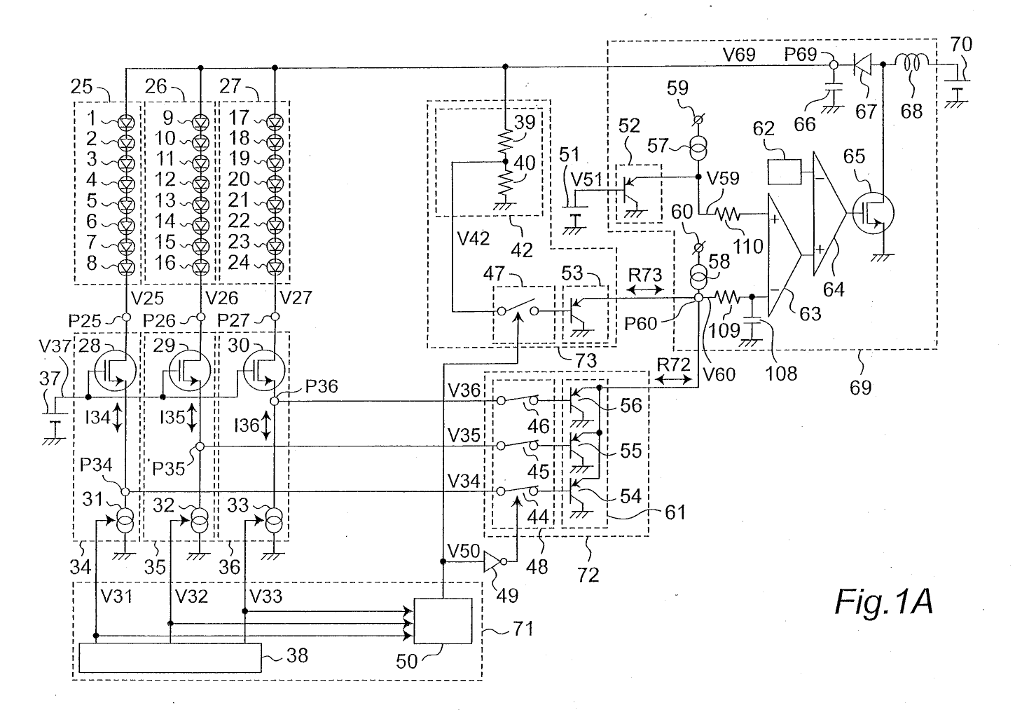

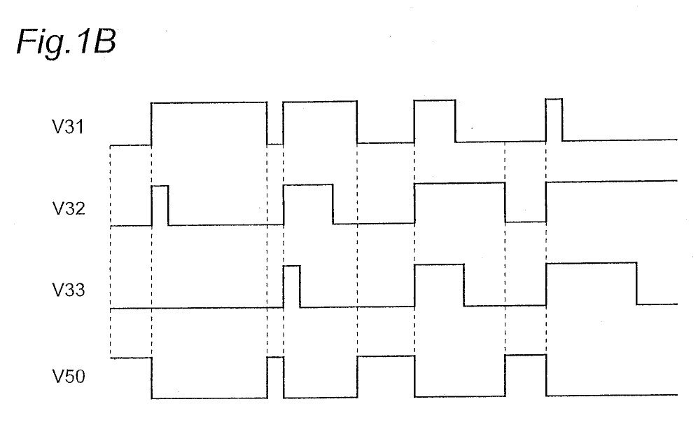

FIG. 1A is a circuit diagram showing a configuration of a light emitting element driving apparatus according to a first embodiment. In FIG. 1A, the light emitting element driving apparatus according to the first embodiment contains a light emitting element group 25, a light emitting element group 26, a light emitting element group 27, a current driving circuit 34, a current driving circuit 35, a current driving circuit 36, a voltage source 37, a voltage source 51, a voltage source 70 (also referred to as a DC power source or a DC voltage source), a control circuit 71, a main feedback circuit 72, an auxiliary feedback circuit 73, an inverter 49, and a power source circuit 69.

The light emitting element group 25 contains a light emitting element 1, a light emitting element 2, a light emitting element 3, a light emitting element 4, a light emitting element 5, a light emitting element 6, a light emitting element 7, and a light emitting element 8. The light emitting element group 26 contains a light emitting element 9, a light emitting element 10, a light emitting element 11, a light emitting element 12, a light emitting element 13, a light emitting element 14, a light emitting element 15, and a light emitting element 16. The light emitting element group 27 contains a light emitting element 17, a light emitting element 18, a light emitting element 19, a light emitting element 20, a light emitting element 21, a light emitting element 22, a light emitting element 23, and a light emitting element 24. The current driving circuit 34 contains an N-channel MOS (negative-channel metal-oxide semiconductor) transistor 28 and a current source 31. The current driving circuit 35 contains an N-channel MOS transistor 29 and a current source 32. The current driving circuit 36 contains an N-channel MOS transistor 30 and a current source 33. A normally-off MOS transistor is used as each of the N-channel MOS transistors 28, 29 and 30.

The control circuit 71 contains a current source control circuit 38 and a state signal generating circuit 50. The main feedback circuit 72 contains a switching circuit 48 and an input setting circuit 61. The switching circuit 48 contains a switch 44, a switch 45, and a switch 46. The input setting circuit 61 contains a PNP transistor 54, a PNP transistor 55 and a PNP transistor 56. The auxiliary feedback circuit 73 contains an auxiliary feedback voltage generating circuit 42, a switching circuit 47 and an input setting circuit 53. The auxiliary feedback voltage generating circuit 42 contains a resistor 39 and a resistor 40. The power source circuit 69 contains a current source 58, a voltage source 60, a difference circuit 63, a resistor 109, a capacitor 108, a resistor 110, a current source 57, a voltage source 59, an input setting circuit 52, a pulse-width modulation circuit 64, a carrier generator 62, a switching device 65, an inductor 68, a diode 67, and a capacitor 66. A Schottky diode is used as the diode 67.

### 1.1.2 Light Emitting Element Groups and Current Driving Circuits

One terminal of the light emitting element group 25 is connected to a power source voltage output terminal P69 from which the power source circuit 69 outputs a power source voltage V69, and the other terminal thereof is connected to one terminal of the current driving circuit 34 via a load connection terminal P25. One terminal of the light emitting element group 26 is connected to the power source voltage output terminal P69, and the other terminal thereof is connected to one terminal of the current driving circuit 35 via a load connection terminal P26. One terminal of the light emitting element group 27 is connected to the power source voltage output terminal P69, and the other terminal thereof is connected to one terminal of the current driving circuit 36 via a load connection terminal P27. The light emitting elements 1 to 24 are formed of light emitting diodes (LEDs), for example. In the light emitting element group 25, all the LEDs 1 to 8 are connected in series in the forward direction from one terminal of the light emitting element group 25 to the other terminal thereof. In the light emitting element group 26, all the LEDs 9 to 16 are connected in series in the forward direction from one terminal of the light emitting element group 26 to the other terminal thereof. In the light emitting element group 27, all the LEDs 17 to 24 are connected in series in the forward direction from one terminal of the light emitting element group 27 to the other terminal thereof.

The other terminal of the current driving circuit 34, the other terminal of the current driving circuit 35 and the other terminal of the current driving circuit 36 are grounded. In the current driving circuit 34, the drain of the N-channel MOS transistor 28 is connected to one terminal of the current driving circuit 34, the source thereof is connected to one terminal of the current source 31 via a feedback output terminal P34, and the gate thereof is connected to the voltage source 37. The other terminal of the current source 31 is connected to the other terminal of the current driving circuit 34, and the control terminal of the current source 31 is connected to the current source control circuit 38. In the current driving circuit 35, the drain of the N-channel MOS transistor 29 is connected to one terminal of the current driving circuit 35, the source thereof is connected to one terminal of the current source 32 via a feedback output terminal P35, and the gate thereof is connected to the voltage source 37. The other terminal of the current source 32 is connected to the other terminal of the current driving circuit 35, and the control terminal of the current source 32 is connected to the current source control circuit 38. In the current driving circuit 36, the drain of the N-channel MOS transistor 30 is connected to one terminal of the current driving circuit 36, the source thereof is connected to one terminal of the current source 33 via a feedback output terminal P36, and the gate thereof is connected to the voltage source 37. The other terminal of the current source 33 is connected to the other terminal of the current driving circuit 36, and the control terminal of the current source 33 is connected to the current source control circuit 38. The current sources 31, 32 and 33 are each formed of an N-channel MOS transistor, for example.

The power source circuit 69 supplies the power source voltage V69 to the respective light emitting element groups 25 to 27. The current driving circuit 34 generates a drive current I34 for driving the light emitting element group 25 and also generates a main feedback voltage V34 at the feedback output terminal P34. The current driving circuit 35 generates a drive current I35 for driving the light emitting element group 26 and also generates a main feedback voltage V35 at the feedback output terminal P35. The current driving circuit 36 generates a drive current I36 for driving the light emitting element group 27 and also generates a main feedback voltage V36 at the feedback output terminal P36. Since the drive current I34 flows through the light emitting element group 25, a load voltage V25 obtained by subtracting the voltage across the terminals of the light emitting element group 25 from the power source voltage V69 appears at the load connection terminal P25. Since the drive current I35 flows through the light emitting element group 26, a load voltage V26 obtained by subtracting the voltage across the terminals of the light emitting element group 26 from the power source voltage V69 appears at the load connection terminal P26. Since the drive current I36 flows through the light emitting element group 27, a load voltage V27 obtained by subtracting the voltage across the terminals of the light emitting element group 27 from the power source voltage V69 appears at the load connection terminal P27. The main feedback voltages V34 to V36 are also simply referred to as feedback voltages.

From a different point of view, the power source circuit 69 supplies the power source voltage V69 to the series circuit of the light emitting element group 25 and the current driving circuit 34, whereby the load voltage V25 is generated at the load connection terminal P25, and the main feedback voltage V34 is generated at the feedback output terminal P34. The power source circuit 69 supplies the power source voltage V69 to the series circuit of the light emitting element group 26 and the current driving circuit 35, whereby the load voltage V26 is generated at the load connection terminal P26, and the main feedback voltage V35 is generated at the feedback output terminal P35. The power source circuit 69 supplies the power source voltage V69 to the series circuit of the light emitting element group 27 and the current driving circuit 36, whereby the load voltage V27 is generated at the load connection terminal P27, and the main feedback voltage V36 is generated at the feedback output terminal P36. The current source 31 passes the drive current I34 through the series circuit of the light emitting element group 25 and the current driving circuit 34. The current source 32 passes the drive current I35 through the series circuit of the light emitting element group 26 and the current driving circuit 35. The current source 33 passes the drive current I36 through the series circuit of the light emitting element group 27 and the current driving circuit 36.

### 1.1.3 Control Circuit

In the control circuit 71, the current source control circuit 38 drives a control signal V31 high to set the current source 31 to the ON state and to turn ON the drive current I34. On the other hand, the current source control circuit 38 drives the control signal V31 low to set the current source 31 to the OFF state and to turn OFF the drive current I34. In the case that the current source 31 is in the ON state or the OFF state, the current driving circuit 34 is in the ON state or the OFF state, respectively. The current source control circuit 38 drives a control signal V32 high to set the current source 32 to the ON state and to turn ON the drive current I35. On the other hand, the current source control circuit 38 drives the control signal V32 low to set the current source 32 to the OFF state and to turn OFF the drive current I35. In the case that the current source 32 is in the ON state or the OFF state, the current driving circuit 35 is in the ON state or the OFF state, respectively. The current source control circuit 38 drives a control signal V33 high to set the current source 33 to the ON state and to turn ON the drive current I36. On the other hand, the current source control circuit 38 drives the control signal V33 low to set the current source 33 to the OFF state and to turn OFF the drive current I36. In the case that the current source 33 is in the ON state or the OFF state, the current driving circuit 36 is in the ON state or the OFF state, respectively.

FIG. 1B is a timing chart showing the operation of the light emitting element driving apparatus according to the first embodiment. The control signals V31 to V33 change between two levels, i.e., high and low levels, at desired timing as shown in FIG. 1B, for example. In this case, the control signals V31 to V33 may be non-periodic or periodic. In the case that the control signals V31 to V33 are periodic, the periods of the control signals V31 to V33 may be different or may be identical. Furthermore, in the case that the control signals V31 to V33 are periodic, the phases of the control signals V31 to V33 may be aligned or may be displaced from one another. This kind of control operation using the control signals V31 to V33 is referred to as duty control.

### 1.1.4 Main Feedback Circuit and Auxiliary Feedback Circuit

In the main feedback circuit 72, one terminal of the switch 44 is connected to the feedback output terminal P34, and the other terminal thereof is connected to the base of the PNP transistor 54. One terminal of the switch 45 is connected to the feedback output terminal P35, and the other terminal thereof is connected to the base of the PNP transistor 55. One terminal of the switch 46 is connected to the feedback output terminal P36, and the other terminal thereof is connected to the base of the PNP transistor 56. The collectors of the PNP transistors 54 to 56 are grounded, and the emitters thereof are connected to the control input terminal P60 of the power source circuit 69. The control input terminal P60 is connected to the voltage source 60 via the current source 58. The main feedback circuit 72 is also simply referred to as a feedback circuit.

When the switch 44 is in the ON state, the base of the PNP transistor 54 receives the main feedback voltage V34. When the switch 45 is in the ON state, the base of the PNP transistor 55 receives the main feedback voltage V35. When the switch 46 is in the ON state, the base of the PNP transistor 56 receives the main feedback voltage V36. By the lowest voltage of the main feedback voltages V34 to V36, the corresponding PNP transistor is turned ON. In other words, by the lowest voltage, the base current of the corresponding PNP transistor is drawn, and a current flows from the current source 58 to the emitter of the corresponding PNP transistor. As a result, the main feedback circuit 72 generates a main feedback signal V60 having a voltage higher than the lowest voltage by the base-emitter voltage of the PNP transistor and applies the main feedback signal V60 to the control input terminal P60. The main feedback signal V60 is also simply referred to as a feedback signal.

For example, in the case that the main feedback voltage V34 is the lowest voltage, the main feedback circuit 72 generates the main feedback signal V60 having a voltage higher than the main feedback voltage V34 by the base-emitter voltage of the PNP transistor 54 and applies the main feedback signal V60 to the control input terminal P60. In other words, the current source 58 is preset so that by the main feedback voltage V34 the corresponding PNP transistor 54 is turned ON without fail. In this case, since the main feedback voltages V35 and V36 are higher than the main feedback voltage V34, both the PNP transistors 55 and 56 are turned OFF. Generally speaking, the base-emitter voltage of a PNP transistor is 0.6 to 0.7 volts in the ON state. As described above, in the case that the switching circuit 48 is in the ON state, the main feedback circuit 72 generates the main feedback signal V60 having a voltage higher than the lowest voltage of the main feedback voltages V34 to V36 by the base-emitter voltage and applies the main feedback signal V60 to the control input terminal P60. Since the main feedback signal V60 is nullified in the case that the switching circuit 48 is in the OFF state, the switching circuit 48 is also referred to as a main nullifying circuit.

In the auxiliary feedback voltage generating circuit 42, one terminal of the resistor 39 is connected to the power source voltage output terminal P69, the other terminal of the resistor 39 is connected to one terminal of the resistor 40, and the other terminal of the resistor 40 is grounded. One terminal of the switching circuit 47 is connected to the other terminal of the resistor 39, and the other terminal of the switching circuit 47 is connected to the base of a PNP transistor contained in the input setting circuit 53. The collector of the PNP transistor contained in the input setting circuit 53 is grounded, and the emitter thereof is connected to the control input terminal P60.

The auxiliary feedback voltage generating circuit 42 receives the power source voltage V69 and divides the power source voltage V69 based on the ratio of the resistance of the resistor 39 and the resistance of the resistor 40, thereby generating an auxiliary feedback voltage V42 that is substantially proportional to the power source voltage V69. In the case that the switching circuit 47 is in the ON state, the base of the PNP transistor contained in the input setting circuit 53 receives the auxiliary feedback voltage V42, and the PNP transistor is turned ON by the auxiliary feedback voltage V42. In other words, by the auxiliary feedback voltage V42, the base current of the PNP transistor contained in the input setting circuit 53 is drawn, and a current flows from the current source 58 to the emitter of the PNP transistor. Hence, in the case that the switching circuit 47 is in the ON state, the auxiliary feedback circuit 73 generates an auxiliary feedback signal V60 having a voltage higher than the auxiliary feedback voltage V42 by the base-emitter voltage of the PNP transistor and applies the auxiliary feedback signal V60 to the control input terminal P60. In other words, in the case that the switching circuit 47 is in the ON state, the current source 58 is preset so that the PNP transistor contained in the input setting circuit 53 is turned ON without fail by the auxiliary feedback voltage V42. Since the auxiliary feedback signal V60 is nullified in the case that the switching circuit 47 is in the OFF state, the switching circuit 47 is also referred to as an auxiliary nullifying circuit.

As shown in FIG. 1B, the state signal generating circuit 50 generates a state signal V50 that becomes high in the case that all the control signals V31 to V33 are low and that becomes low in the case that at least one of the control signals V31 to V33 is high. The state signal generating circuit 50 controls the switching circuit 48 based on the inversion signal of the state signal V50 inverted by the inverter 49, and controls the switching circuit 47 based on the state signal V50. Hence, in the case that the state signal V50 is low, the main feedback circuit 72 applies the main feedback signal V60 to the control input terminal P60. On the other hand, in the case that the state signal V50 is high, the auxiliary feedback circuit 73 applies the auxiliary feedback signal V60 to the control input terminal P60.

In the case that one or more of the current sources 31 to 33 are in the ON state (that is, one or more of the current driving circuits 34 to 36 is in the ON state), this state is referred to as a light emitting element ON state. In the case that all the current sources 31 to 33 are in the OFF state (that is, all the current driving circuits 34 to 36 are in the OFF state), this state is referred to as a light emitting element OFF state. In the case that the state signal V50 is low, the light emitting element ON state is obtained, and in the case that the state signal V50 is high, the light emitting element OFF state is obtained.

Three routes described below are referred to as main routes R72. A first main route is a route from the power source voltage output terminal P69 to the control input terminal P60 via the light emitting element group 25, the load connection terminal P25, the current driving circuit 34, the feedback output terminal P34, and the switch 44 and the PNP transistor 54 inside the main feedback circuit 72. A second main route is a route from the power source voltage output terminal P69 to the control input terminal P60 via the light emitting element group 26, the load connection terminal P26, the current driving circuit 35, the feedback output terminal P35, and the switch 45 and the PNP transistor 55 inside the main feedback circuit 72. A third main route is a route from the power source voltage output terminal P69 to the control input terminal P60 via the light emitting element group 27, the load connection terminal P27, the current driving circuit 36, the feedback output terminal P36, and the switch 46 and the PNP transistor 56 inside the main feedback circuit 72. A route from the power source voltage output terminal P69 to the control input terminal P60 via the auxiliary feedback voltage generating circuit 42, the switching circuit 47 and the input setting circuit 53 inside the auxiliary feedback circuit 73 is referred to as an auxiliary route R73.

In the main routes R72, three routes described below are particularly referred to as main feedback routes. A first main feedback route is a route from the feedback output terminal P34 to the control input terminal P60 via the switch 44 and the PNP transistor 54 inside the main feedback circuit 72. A second main feedback route is a route from the feedback output terminal P35 to the control input terminal P60 via the switch 45 and the PNP transistor 55 inside the main feedback circuit 72. A third main feedback route is a route from the feedback output terminal P36 to the control input terminal P60 via the switch 46 and the PNP transistor 56 inside the main feedback circuit 72.

### 1.1.5 Power Source Circuit

In the power source circuit 69, the base of the PNP transistor contained in the input setting circuit 52 receives a reference voltage 51 from the voltage source 51, the collector thereof is grounded, and the emitter thereof is connected to the voltage source 59 via the current source 57. The PNP transistor contained in the input setting circuit 52 is turned ON by the reference voltage V51. In other words, by the reference voltage V51, the base current of the PNP transistor contained in the input setting circuit 52 is drawn, and a current flows from the current source 57 to the emitter of the PNP transistor. The input setting circuit 52 generates a reference signal V59 having a voltage higher than the reference voltage V51 by the base-emitter voltage of the PNP transistor at the emitter. In other words, the current source 57 is preset so that the PNP transistor contained in the input setting circuit 52 is turned ON without fail by the reference voltage V51.

The voltage generated from the voltage source 59 is substantially equal to the voltage generated from the voltage source 60, and the current generated from the current source 57 is substantially equal to the current generated from the current source 58. Furthermore, the characteristics of the PNP transistor contained in the input setting circuit 52 are substantially equivalent to the characteristics of the PNP transistors 54 to 56 contained in the input setting circuit 61 and the PNP transistor contained in the input setting circuit 53. Hence, the base-emitter voltage of the PNP transistor contained in the input setting circuit 52 is substantially equal to the base-emitter voltages of the PNP transistors 54 to 56 contained in the input setting circuit 61 and the PNP transistor contained in the input setting circuit 53. As a result, when it is assumed that the main feedback signal V60 is substantially equal to the reference signal V59, the main feedback voltages V34 to V36 are substantially equal to the reference voltage V51. Similarly, when it is assumed that the auxiliary feedback signal V60 is substantially equal to the reference signal V59, the auxiliary feedback voltage V42 is substantially equal to the reference voltage V51. The voltage drop in each of the switching circuits 47 and 48 in the ON state is ignored because the voltage drop is very small.

The resistor 109 is connected between the control input terminal P60 and the inverting input terminal of the difference circuit 63, and the capacitor 108 is connected between the inverting input terminal of the difference circuit 63 and the ground terminal. Furthermore, the resistor 110 is connected between the current source 57 and the non-inverting input terminal of the difference circuit 63. The resistor 109 and the capacitor 108 form a low-pass filter. The difference circuit 63 receives the main feedback signal V60 or the auxiliary feedback signal V60 from the control input terminal P60 via this low-pass filter at the inverting input terminal, and receives the reference signal V59 via the resistor 110 at the non-inverting input terminal. The difference circuit 63 generates a difference signal representing a signal obtained by subtracting the main feedback signal V60 or the auxiliary feedback signal V60 filtered by the low-pass filter from the reference signal V59. Since the difference circuit 63 amplifies the error signal between the reference signal V59 and the main feedback signal V60 or the auxiliary feedback signal V60 and generates the difference signal, the difference circuit 63 is also referred to as an error amplifier. The carrier generator 62 generates a desired carrier signal, such as a triangular signal. The pulse-width modulation circuit 64 receives the difference signal at the non-inverting input terminal thereof, receives the carrier signal at the inverting input terminal thereof, compares the difference signal with the carrier signal, and generates a pulse-width modulation signal representing the result of the comparison. Since the pulse-width modulation circuit 64 generates the signal representing the result of the comparison between the difference signal and the carrier signal, the pulse-width modulation circuit 64 is also referred to as a comparison circuit. The switching device 65 receives the pulse-width modulation signal at the gate thereof, and is turned ON/OFF by the pulse-width modulation signal. The inductor 68 is charged and discharged with the power from the DC voltage source 70 depending on the ON operation and the OFF operation of the switching device 65. The diode 67 passes the discharged power in the forward direction. The capacitor 66 is charged with the passed power, and the power source voltage V69 is generated at the power source voltage output terminal P69. As described above, the power source circuit 69 serves as a step-up power source circuit that generates the DC power source voltage V69 larger than the DC voltage generated from the voltage source 70.

In the case that the main feedback signal V60 or the auxiliary feedback signal V60 is smaller than the reference signal V59, the difference signal rises, the high-level period of the pulse-width modulation signal becomes longer, and the ON-period of the switching device 65 becomes longer. Hence, the charging period of the inductor 68 becomes longer, and the power source voltage V69 rises. As the power source voltage V69 rises, the main feedback signal V60 or the auxiliary feedback signal V60 becomes larger (as described later), and the main feedback signal V60 or the auxiliary feedback signal V60 becomes substantially equal to the reference signal V59. Conversely, in the case that the main feedback signal V60 or the auxiliary feedback signal V60 is larger than the reference signal V59, the difference signal lowers, the high-level period of the pulse-width modulation signal becomes shorter, and the ON-period of the switching device 65 becomes shorter. Hence, the charging period of the inductor 68 becomes shorter, and the power source voltage V69 lowers. As the power source voltage V69 lowers, the main feedback signal V60 or the auxiliary feedback signal V60 becomes smaller (as described later), and the main feedback signal V60 or the auxiliary feedback signal V60 becomes substantially equal to the reference signal V59.

### 1.1.6 Summary of Configuration and Operation

As described above, in the case of the light emitting element ON state, the control circuit 71 sets the switching circuit 48 to the ON state and sets the switching circuit 47 to the OFF state. The main feedback circuit 72 feeds back the main feedback voltages V34 to V36 to the power source circuit 69 via the main routes R72. The power source circuit 69 adjusts and stabilizes the power source voltage V69 based on the main feedback voltages V34 to V36. On the other hand, in the case of the light emitting element OFF state, the control circuit 71 sets the switching circuit 48 to the OFF state and sets the switching circuit 47 to the ON state. The auxiliary feedback circuit 73 feeds back the auxiliary feedback voltage V42 to the power source circuit 69 via the auxiliary route R73. The power source circuit 69 adjusts and stabilizes the power source voltage V69 based on the auxiliary feedback voltage V42.

Hence, in the case of the light emitting element OFF state, since the adjustment operation of the power source circuit 69 is continued using the auxiliary feedback circuit 73, the power source voltage V69 is stabilized to a predetermined voltage even in the light emitting element OFF state. Hence, in both the light emitting element OFF state and the light emitting element ON state, even if the period of the light emitting element OFF state becomes long, the width of fluctuations including ripples and the like in the power source voltage V69 can be made sufficiently small. As a result, since the current sources 31 to 33 can maintain a voltage sufficient to perform current driving at all times, when the light emitting element OFF state is switched to the light emitting element ON state, the responsiveness of the current driving circuits 34 to 36 can be enhanced. Furthermore, since the power source voltage V69 is prevented from rising excessively in the light emitting element OFF state, withstand voltage breakdown is prevented, power consumption is reduced due to decrease in power loss, and EMI (electro-magnetic interference) is also reduced in the light emitting element driving apparatus. As described above, the light emitting element driving apparatus according to the first embodiment can perform accurate duty control using the auxiliary feedback circuit 73.

The current sources 31 to 33 generate the drive currents I34 to I36 sufficient to current-drive the light emitting element groups 25 to 27, respectively. For this purpose, the components of the current sources 31 to 33 are required to be relatively large in size corresponding to the drive currents I34 to I36. As a result, there is a possibility that leak currents from the input setting circuit 61 to the current sources 31 to 33 may be generated. However, the switching circuit 48 has a function of shutting off the main routes R72 in the light emitting element OFF state as described above. In addition, since the switching circuit 48 shuts off the main routes R72 in the light emitting element OFF state and inhibits the above-mentioned leak currents, the possibility of malfunctions in the input setting circuit 61 is prevented and power consumption due to leak currents can be reduced.

### 1.2 Voltage Distribution

Voltage distribution in the light emitting element groups 25 to 27 and the current driving circuits 34 to 36 or in the auxiliary feedback circuit 73 will be described below in cases in which the number of the current driving circuits being in the ON state is 0 to 3.

### 1.2.1 In the Case that Any One of the Current Driving Circuits is in the ON State

First, a case in which any one of the current driving circuits 34 to 36 is in the ON state in the light emitting element ON state, that is, a case in which any one of the current sources 31 to 33 is in the ON state, will be described below. In the case that only the current source 31 of the current sources 31 to 33 is in the ON state, when it is assumed that the voltage across the terminals of the light emitting element group 25 is VF25, that the drive current of the current driving circuit 34 is I34 and that the ON resistance of the N-channel MOS transistor 28 is R28, the value V69A of the power source voltage V69 can be represented by Expression 1 since the main feedback voltage V34 is substantially equal to the reference voltage V51.

V69A=VF25+R28×I34+V51 (1)

Similarly, in the case that only the current source 32 of the current sources 31 to 33 is in the ON state, when it is assumed that the voltage across the terminals of the light emitting element group 26 is VF26, that the drive current of the current driving circuit 35 is I35 and that the ON resistance of the N-channel MOS transistor 29 is R29, the value V69B of the power source voltage V69 can be represented by Expression 2 since the main feedback voltage V35 is substantially equal to the reference voltage V51.

V69B=VF26+R29×I35+V51 (2)

Similarly, in the case that only the current source 33 of the current sources 31 to 33 is in the ON state, when it is assumed that the voltage across the terminals of the light emitting element group 27 is VF27, that the drive current of the current driving circuit 36 is I36 and that the ON resistance of the N-channel MOS transistor 30 is R30, the value V69C of the power source voltage V69 can be represented by Expression 3 since the main feedback voltage V36 is substantially equal to the reference voltage V51.

V69C=VF27+R30×I36+V51 (3)

In other words, the power source circuit 69 adjusts each of the power source voltages V69A to V69C based on the main feedback voltage of one of the current driving circuits 34 to 36 being in the ON state.

The power source voltages V69A to V69C change with one another depending on variations in the voltages VF25 to VF27 across the terminals of the light emitting element groups and depending on variations in the ON voltages (R28×I34, R29×I35 and R30×I36) of the N-channel MOS transistors, respectively. For example, it is assumed that the relationship among the power source voltages V69A to V69C is represented by Expression 4.

V69A>V69B>V69C (4)

When it is assumed that the power source voltage V69 is V69on1 in the case that any one of the current driving circuits 34 to 36 is in the ON state in the light emitting element ON state, the power source voltage V69on1 varies to the three values V69A, V69B and V69C.

In addition, the main feedback voltages of the two current driving circuits being in the OFF state have a value between a reference voltage V37 and a voltage obtained by subtracting the threshold voltage of the corresponding two normally-off N-channel MOS transistors from the reference voltage V37. Hence, the main feedback voltages of the two current driving circuits being in the OFF state become higher than the main feedback voltage of the one current driving circuit being in the ON state, and become the reference voltage V37 or less at maximum.

Furthermore, the load voltages of the two current driving circuits being in the OFF state rise to less than but close to the power source voltage V69on1 (that is, V69A, V69B or V69C) since the voltages across the terminals of the corresponding two light emitting element groups become small.

### 1.2.2 In the Case That All the Current Driving Circuits are in the ON State

In the case that all the current driving circuits 34 to 36 are in the ON state in the light emitting element ON state, it is assumed that the power source voltage V69 has reached V69on3. In this case, the power source voltages V69A to V69C represented by Expressions 1 to 3 coincide with the power source voltage V69on3, and the main feedback voltages have individual values, such as V34, V35 and V36, whereby the power source voltages V69A to V69C can be represented by Expressions 5 to 7.

V69on3=VF25+R28×I34+V34 (5)

V69on3=VF26+R29×I35+V35 (6)

V69on3=VF27+R30×I36+V36 (7)

In this case, the magnitude relationship among the main feedback voltages V34 to V36 can be represented by Expression 8 based on Expressions 1 to 7. In other words, in the case that the highest power source voltage is V69A when any one of the current driving circuits 34 to 36 is in the ON state, the main feedback voltage V34 corresponding to the power source voltage V69A becomes lowest in the case that all the current driving circuits are in the ON state.

V34<V35<V36 (8)

Furthermore, since the power source circuit 69 causes the lowest main feedback voltage V34 of the main feedback voltages V34 to V36 to be substantially equal to the reference voltage V51, Expressions 5 and 8 are represented by Expressions 9 and 10, respectively.

V69on3=VF25+R28×I34+V51 (9)

V34=V51<V35<V36 (10)

In other words, the power source circuit 69 adjusts the power source voltage V69on3 based on the lowest main feedback voltage V34 of the main feedback voltages V34 to V36.

As described above, the reference voltage V51 becomes equal to the lowest voltage V34 of the main feedback voltages V34 to V36. Hence, the reference voltage V51 is set to the lowest voltage at which the current source 31 corresponding to the main feedback voltage V34 is in the ON state and can sufficiently perform current driving.

Moreover, the reference voltage V37 generated by the voltage source 37 is set to a voltage higher than the main feedback voltages V34 to V36, varying while the reference voltage V51 is used as the lowest voltage, by the gate-source voltage at which the normally-off N-channel MOS transistor is set to the ON state. It is herein noted that the gate-source voltage is higher than the threshold voltage of the N-channel MOS transistor by a predetermined value and that the ON voltage and the ON resistance of the N-channel MOS transistor are sufficiently low. Hence, the reference voltage V37 becomes a voltage obtained by totalizing the lowest voltage (that is, the reference voltage V51) at which the current sources 31 to 33 can sufficiently perform current driving, the fluctuation range of the main feedback voltage V34 to V36 (that is, the fluctuation range of the sum of the voltage across the terminals of the light emitting element groups 25 to 27 and the ON voltage of the N-channel MOS transistors 28 to 30) and the gate-source voltage at which the N-channel MOS transistor is set to the ON state.

### 1.2.3 In the Case That Any Two of the Current Driving Circuits are in the ON State

In the case that any two of the current driving circuits 34 to 36 are in the ON state in the light emitting element ON state, it is assumed that the power source voltage V69 has reached V69on2. In this case, the power source voltage V69on2 varies in three ways depending on three combinations corresponding to the ON states of the power source voltages V69A to V69C represented by Expressions 1 to 3 (that is, the combination of V69A and V69B, the combination of V69B and V69C, and the combination of V69C and V69A).

Furthermore, the power source circuit 69 causes the lower main feedback voltage V34 of the two main feedback voltages of the current driving circuits being in the ON state to be substantially equal to the reference voltage V51.

In other words, the power source circuit 69 adjusts the power source voltage V69on2 based on the lower main feedback voltage of the two main feedback voltages of the current driving circuits being in the ON state.

In this case, the main feedback voltage in the one current driving circuit being in the OFF state has a value between the reference voltage V37 and a voltage obtained by subtracting the threshold voltage of the corresponding one normally-off N-channel MOS transistor from the reference voltage V37. Hence, the main feedback voltage in the one current driving circuit being in the OFF state becomes higher than the main feedback voltages of the two current driving circuits being in the ON state, and becomes the reference voltage V37 or less at maximum.

Furthermore, the load voltage of the one current driving circuit being in the OFF state rises to less than but close to the power source voltage V69on2 since the voltage across the terminals of the corresponding one light emitting element group becomes small.

### 1.2.4 Summary of the Light Emitting Element ON State

The power source voltages V69on3, V69on2 and V69on1 are collectively referred to as power source voltage V69on in the light emitting element ON state. The power source voltage V69on1 fluctuates depending on one current driving circuit being in the ON state, the power source voltage V69on2 fluctuates depending on the combination of two current driving circuits being in the ON state, and the power source voltage V69on3 does not fluctuate. The fluctuation width of the power source voltage V69on1 is the largest since it is directly reflected by the fluctuations in the power source voltages V69A to V69C. The fluctuation width of the power source voltage V69on2 is less than that of the power source voltage V69on1 since the fluctuations in the power source voltages V69A to V69C are averaged to some extent.

### 1.2.5 In the Case of the Light Emitting Element OFF State

Next, in the case of the light emitting element OFF state, when it is assumed that the resistances of the resistors 39 and 40 are R39 and R40, respectively, since the power source circuit 69 causes the auxiliary feedback voltage V42 in the auxiliary feedback circuit 73 to be substantially equal to the reference voltage V51, the value V69off of the power source circuit 69 is represented by Expression 11.

V69off=V51×(R39+R40)/R40 (11)

In Expression 11, the reference voltage V51 is proportional to the power source voltage V69off. In other words, as the reference voltage V51 rises, the power source voltage V69off becomes larger, and as the reference voltage V51 lowers, the power source voltage V69off becomes smaller.

In other words, the power source circuit 69 adjusts the power source voltage V69off based on the auxiliary feedback voltage V42.

In this case, the main feedback voltages V34 to V36 in the three current driving circuits 34 to 36 being in the OFF state have a value between the reference voltage V37 and a voltage obtained by subtracting the threshold voltage of the three normally-off N-channel MOS transistors from the reference voltage V37, and become the reference voltage V37 or less at maximum.

Furthermore, the load voltages V25 to V27 of the three current driving circuits 34 to 36 being in the OFF state rise to less than but close to the power source voltage V69off since the voltages across the terminals of the corresponding three light emitting element groups 25 to 27 become small.

### 1.2.6 Specific Examples of Voltage Distribution

A specific example of voltage distribution will be described below. It is assumed that the voltage of the voltage source 70 is 24 V and that all the current driving circuits 34 to 36 are in the ON state or in the OFF state without being switched. In the case that all the current driving circuits 34 to 36 are in the ON state, when it is assumed that the power source voltage V69on is 26.9 V, the reference voltage V51 is 0.4 V and the reference voltage V37 is 4.3 V, the load voltages V25 to V27 become 0.5 V, 0.6 V and 0.8 V, respectively, all the ON resistances of the N-channel MOS transistors 28 to 30 become 1.67Ω, the main feedback voltages V34 to V36 become 0.4 V, 0.5 V and 0.7 V, respectively, and all the drive currents I34 to I36 become 60 mA.

On the other hand, in the case that all the current driving circuits 34 to 36 are in the OFF state, when it is assumed that the power source voltage V69off is 27.07 V, the reference voltage V51 is 0.4 V and the reference voltage V37 is 4.3 V, the resistance R39 becomes 220 kΩ, the resistance R40 becomes 3.3 kΩ, the auxiliary feedback voltage V42 becomes 0.4 V, all the load voltages V25 to V27 become less than but close to 27.07 V, all the main feedback voltages V34 to V36 become a voltage substantially between 4.3 V and 0.7 V, and all the drive currents I34 to I36 become 0 mA.

As described above, in the case that the current driving circuits 34 to 36 are in the ON state and in the OFF state, the load voltages V25 to V27 change from several tenths of 1 V to close to 27.07 V, but the main feedback voltages V34 to V36 change only in the range from several tenths of 1 V to 4 V plus several tenths of 1 V at maximum. In addition, the lowest voltage of the main feedback voltages V34 to V36 is maintained at 0.4 V being equal to the reference voltage V51.

### 1.2.7 Summary of Voltage Distribution

As described above, by setting the reference voltage V51 to the lowest voltage of the main feedback voltages V34 to V36, the main feedback voltages V34 to V36 are set to the lowest voltage at which the current sources 31 to 36 are in the ON state and can sufficiently perform current driving. Hence, the voltages applied to the circuits connected in parallel between the feedback output terminals P34 to P36 and the ground, such as the current sources 31 to 33, the main feedback circuit 72, the auxiliary feedback circuit 73 and the input setting circuit 52, are set to lowest yet sufficient voltages, whereby the power consumed in these circuits can be reduced.

Furthermore, the reference voltage V37 is set to a voltage that is higher than the main feedback voltage of the current driving circuit being in the ON state by the gate-source voltage at which the normally-off N-channel MOS transistor is set to the ON state. Hence, in the case that the current driving circuits corresponding to the main feedback voltages V34 to V36 are in the ON state, the main feedback voltages V34 to V36 become lower than the reference voltage V37 by the above-mentioned gate-source voltage, and in the case that the corresponding current driving circuits are in the OFF state, the main feedback voltages V34 to V36 become the reference voltage V37 or less at maximum. As a result, the main feedback voltages V34 to V36 can be set to the reference voltage V37 or less regardless of the ON/OFF states of the current driving circuits 34 to 36. Hence, the voltages applied to the circuits connected in parallel between the feedback output terminals P34 to P36 and the ground, such as the current sources 31 to 33, the main feedback circuit 72, the auxiliary feedback circuit 73 and the input setting circuit 52, can be limited to the reference voltage V37 or less. These circuits connected in parallel between the feedback output terminals P34 to P36 and the ground should only be configured using components having a low withstand voltage (substantially several volts in the above-mentioned specific example) higher than the reference voltage V37 by a desired margin, whereby the areas of the semiconductor chips for the circuits are decreased. As a result, the power consumption of the light emitting element driving apparatus can be reduced, and the cost thereof can also be reduced.

In addition, by using components having a high drain withstand voltage (several ten volts in the above-mentioned specific example) as the N-channel MOS transistors 28 to 30, the number of the light emitting elements connected in series in the respective light emitting element groups 25 to 27 can be increased, and the voltages across the terminals of the light emitting element groups 25 to 27 can be raised. Hence, the numbers of the light emitting element groups, the N-channel MOS transistors, the current sources, etc. can be reduced. As a result, the power consumption of the light emitting element driving apparatus can be reduced, and the cost thereof can also be reduced.

For this reason, by using components having a high withstand voltage of several ten volts as the N-channel MOS transistors 28 to 30 and by using components having a low withstand voltage of several volts in the circuits connected in parallel between the feedback output terminals P34 to P36 and the ground, such as the current sources 31 to 33, the main feedback circuit 72, the auxiliary feedback circuit 73, and the input setting circuit 52, both the high-voltage driving of the light emitting element groups 25 to 27 and the use of the low withstand voltage components can be achieved.

### 1.2.8 Optimal Setting of the Power Source Voltage V69off

Since the auxiliary feedback voltage V42 becomes equal to the reference voltage V51, the power source voltage V69off in the light emitting element OFF state can be set to a desired value with respect to the power source voltage V69on in the light emitting element ON state by adjusting the resistances R39 and R40 using Expression 11. In the specific example described above, it is assumed that the power source voltage V69on is 26.9 V and the power source voltage V69off is 27.07 V.

The responsiveness of the drive currents I34 to I36 in the case that the light emitting element OFF state is switched to the light emitting element ON state can be raised by setting the power source voltage V69off so as to be slightly higher than the power source voltage V69on. The power loss of the light emitting element driving apparatus in the case that the light emitting element OFF state is switched to the light emitting element ON state can be reduced by setting the power source voltage V69off so as to be slightly lower than the power source voltage V69on. Even if the drive currents I34 to I36 change and thus the power source voltage V69on changes, fluctuations such as ripples in the respective power source voltages V69off and V69on when switching is performed between the light emitting element OFF state and the light emitting element ON state can be reduced by setting the power source voltage V69off so as to be equal to the power source voltage V69on.

Furthermore, in the case that the light emitting element OFF state immediately after the voltage source 70 was started is first switched to the light emitting element ON state, the responsiveness of the drive currents I34 to I36 can also be raised similarly by setting the power source voltage V69off so as to be slightly higher than the power source voltage V69on.

In the case that switching is performed between the light emitting element OFF state and the light emitting element ON state and in the case that the power source voltage V69 changes among the three different power source voltages V69A, V69B and V69C in the light emitting element ON state, the degree of change in the voltage at the inverting input terminal of the difference circuit 63 becomes gentle with respect to time due to the capacitor 108 and the resistor 109. In addition, the voltage at the inverting input terminal of the difference circuit 63 is apt to be maintained transiently at a voltage close to the voltage at the non-inverting input terminal of the difference circuit 63. As a result, the fluctuations in the power source voltage V69 become gentle, and ripples and steep fluctuations are reduced. Both the input terminals of the difference circuit 63 are formed of the gate terminals of MOS transistors or the base terminals of bipolar transistors, and the resistor 110 is disposed at the non-inverting input terminal of the difference circuit 63 to balance the two voltages at the two input terminals.

### 1.3 Summary of the First Embodiment

As described above, in the light emitting element driving apparatus according to the first embodiment, in the case of the light emitting element OFF state, since the adjustment operation of the power source circuit 69 is continued using the auxiliary feedback circuit 73, the power source voltage V69 is stabilized to a predetermined voltage even in the light emitting element OFF state. Hence, in both the light emitting element OFF state and the light emitting element ON state, even if the period of the light emitting element OFF state becomes long, the width of fluctuations including ripples and the like in the power source voltage V69 can be made sufficiently small. As a result, since the current sources 31 to 33 can maintain a voltage sufficient to perform current driving at all times, when the light emitting element OFF state is switched to the light emitting element ON state, the responsiveness of the current driving circuits 34 to 36 can be enhanced. Furthermore, since the power source voltage V69 is prevented from rising excessively in the light emitting element OFF state, withstand voltage breakdown is prevented, power consumption is reduced, and EMI is also reduced in the light emitting element driving apparatus. As described above, the light emitting element driving apparatus can perform accurate duty control using the auxiliary feedback circuit 73.

Furthermore, the power source voltage V69off in the light emitting element OFF state can be set to a desired value with respect to the power source voltage V69on in the light emitting element ON state. The responsiveness of the drive currents I34 to I36 in the case that the light emitting element OFF state is switched to the light emitting element ON state can be raised by setting the power source voltage V69off so as to be slightly higher than the power source voltage V69on. The power loss of the light emitting element driving apparatus in the case that the light emitting element OFF state is switched to the light emitting element ON state can be reduced by setting the power source voltage V69off so as to be slightly lower than the power source voltage V69on. Moreover, since the capacitor 108 and the resistor 109 are provided at the inverting input terminal of the difference circuit 63, in the case that switching is performed between the light emitting element OFF state and the light emitting element ON state and in the case that the power source voltage V69 changes among the three different power source voltages V69A, V69B and V69C in the light emitting element ON state, the degree of change in the voltage at the inverting input terminal of the difference circuit 63 becomes gentle with respect to time due to the capacitor 108 and the resistor 109. For this reason, fluctuations such as ripples and the like and steep fluctuations in the power source voltage V69 can be suppressed.

In addition, in the light emitting element driving apparatus according to the first embodiment, the current driving circuits 34 to 36 are formed of N-channel MOS transistors 28 to 30 and the current sources 31 to 33. Hence, by using components having a high withstand voltage as the N-channel MOS transistors 28 to 30 and by using components having a low withstand voltage in the circuits connected in parallel between the feedback output terminals P34 to P36 and the ground, such as the current sources 31 to 33, the main feedback circuit 72, the auxiliary feedback circuit 73 and the input setting circuit 52, both the high-voltage driving of the light emitting element groups 25 to 27 and the use of the low withstand voltage components can be achieved. By the use of components having a high withstand voltage, the numbers of the light emitting element groups, the N-channel MOS transistors, the current sources, etc. can be reduced. As a result, the power consumption of the light emitting element driving apparatus can be reduced, and the cost thereof can also be reduced. Furthermore, by the use of components having a high withstand voltage, the areas of the semiconductor chips for the circuits are decreased. As a result, the power consumption of the light emitting element driving apparatus can be reduced, and the cost thereof can also be reduced.

### 1.4 Modification Example

In the light emitting element OFF state, the drive currents I34 to I36 may be 0 mA as in the above-mentioned specific example or may have a current value slightly larger than 0 mA. Even in the case that the drive currents I34 to I36 are slightly larger than 0 mA, the drive currents I34 to I36 are set to a current value obviously smaller than that obtained in the light emitting element ON state. There is a possibility that the operations of the current driving circuits 34 to 36 are stabilized by setting the drive currents I34 to I36 to a value slightly larger than 0 mA.

The power source circuit 69 may be a step-down power source circuit that generates the power source voltage V69 smaller than the DC voltage generated from the voltage source 70.

The state signal generating circuit 50 may independently control the switches 44, 45 and 46 of the switching circuit 48. In this case, the state signal generating circuit 50 sets the switch 44 to the ON state when the control signal V31 is high, sets the switch 44 to the OFF state when the control signal V31 is low, sets the switch 45 to the ON state when the control signal V32 is high, sets the switch 45 to the OFF state when the control signal V32 is low, sets the switch 46 to the ON state when the control signal V33 is high, and sets the switch 46 to the OFF state when the control signal V33 is low. Hence, since only the switch connected to the current source being in the ON state is set to the ON state, a leak current from the input setting circuit 61 to the current source being in the OFF state is shut off in the light emitting element ON state, and power consumption due to the leak current is reduced.

Although the number of the light emitting elements contained in each of the light emitting element groups 25 to 27 is eight, the number of the light emitting elements contained therein may be a number other than eight.

Furthermore, although the number of the series circuits of the light emitting element groups and the current driving circuits is three, the number may be, for example, one or two or four to 15, other than three.

Moreover, although the current driving circuits 34 to 36 are formed of the N-channel MOS transistors 28 to 30 and the current sources 31 to 33, respectively, they may also be formed of only the current sources 31 to 33, respectively. In this case, the load connection terminals P25 to P27 coincide with the feedback output terminals P34 to P36, respectively, and the load voltages V25 to V27 coincide with the main feedback voltage V34 to V36, respectively. Even in the light emitting element driving apparatus configured as described above, since the adjustment operation of the power source circuit 69 is also continued using the auxiliary feedback circuit 73 in the light emitting element OFF state, the power source voltage V69 is stabilized.

Still further, although the current driving circuits 34 to 36 each contain one transistor and one current source and the transistor is formed of an N-channel MOS transistor, at least one of the transistors of the current driving circuits may be an NPN transistor or an IGBT (insulated gate bipolar transistor).

In addition, the control circuit 71 may further contain an auxiliary feedback voltage control circuit, and the auxiliary feedback voltage control circuit may control the auxiliary feedback voltage generating circuit 42 to change the auxiliary feedback voltage V42. In this case, the auxiliary feedback voltage generating circuit 42 is formed of, for example, variable resistors serving as the resistors 39 and 40, and the auxiliary feedback voltage control circuit controls the resistors 39 and 40 to change the resistances thereof, thereby changing the auxiliary feedback voltage V42.

### 2. Second Embodiment

In the following description of a second embodiment, differences from the first embodiment will be mainly described. Since the configurations, operations and effects other than those relating to the differences are similar to those according to the first embodiment, their descriptions are omitted.

In the description of the second embodiment, a configuration in which at least one of the switching circuit 47 and the switching circuit 48 is omitted will be described.

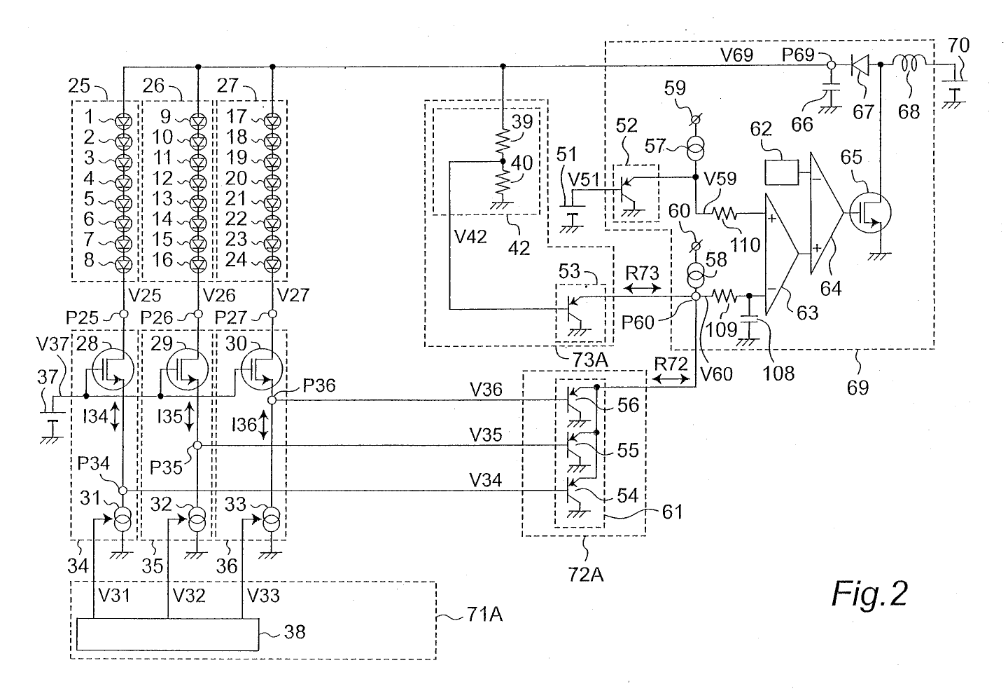

FIG. 2 is a circuit diagram showing a configuration of a light emitting element driving apparatus according to the second embodiment. The configuration of the second embodiment shown in FIG. 2 is different from the configuration of the first embodiment shown in FIG. 1A in that the switching circuit 48, the switching circuit 47, the inverter 49 and the state signal generating circuit 50 are omitted. The auxiliary feedback voltage generating circuit 42 is connected to the input setting circuit 53 at all times, and the current driving circuits 34 to 36 are connected to the input setting circuit 61 at all times. The main feedback circuit 72, the auxiliary feedback circuit 73 and the control circuit 71 are altered to a main feedback circuit 72A, an auxiliary feedback circuit 73A and a control circuit 71A, respectively.

Table 1 shows the ON/OFF states of the switching circuits 48 and 47 being controlled in the light emitting element ON state and the light emitting element OFF state.

TABLE 1

| | | Switching | Switching |
|---|---|---|---|
| | V69off | circuit 47 | circuit 48 |
| Light emitting | Higher than any of V69A | (a) OFF | (e) ON |
| element ON | to V69C | | |
| state | Between the highest | (b) Third | |
| | voltage and the lowest | embodiment | |
| | voltage of V69A to V69C | | |
| | Lower than any of V69A | (c) ON/OFF | |
| | to V69C | | |
| Light emitting | — | (d) ON | (f) ON/OFF |
| element OFF | | | |
| state | | | |

First, in the light emitting element ON state, the switching circuit 48 is in the ON state as shown in (e) of Table 1, and in the light emitting element OFF state, the switching circuit 47 is in the ON state as shown in (d) of Table 1.

Next, in the light emitting element OFF state, the switching circuit 48 according to the first embodiment is in the OFF state. However, the main feedback voltages V34 to V36 are sufficiently higher than the auxiliary feedback voltage V42 in the light emitting element OFF state regardless of whether the power source voltage V69off in the light emitting element OFF state is higher or lower than the power source voltages V69A, V69B and V69C. Hence, the auxiliary feedback signal is generated at the control input terminal P60 regardless of whether the switching circuit 48 is in the ON state or in the OFF state as shown in (f) of Table 1. For this reason, the switching circuit 48 can be set to the ON state at all times regardless of the light emitting element ON state and the light emitting element OFF state. As a result, the switching circuit 48 and the inverter 49 can be omitted as shown in FIG. 2, and the current driving circuits 34 to 36 can be connected to the input setting circuit 61 at all times. However, in the case that the function of preventing leak currents from flowing from the input setting circuit 61 to the current sources 31 to 33 is used by shutting off the main routes R72 in the light emitting element OFF state as described in the first embodiment, the switching circuit 48 is used.

Furthermore, in the light emitting element ON state, the switching circuit 47 according to the first embodiment is in the OFF state. However, if the power source voltage V69off is lower than any of the power source voltage V69A, V69B and V69C, the auxiliary feedback voltage V42 is higher than the main feedback voltages V34 to V36 in the light emitting element ON state. Hence, the main feedback signal is generated at the control input terminal P60 regardless of whether the switching circuit 47 is in the ON state or in the OFF state as shown in (c) of Table 1. Hence, the switching circuit 47 can be set to the ON state at all times regardless of the light emitting element ON state and the light emitting element OFF state. As a result, the switching circuit 47 can be omitted as shown in FIG. 2, and the auxiliary feedback voltage generating circuit 42 can be connected to the input setting circuit 53 at all times.

Moreover, if the power source voltage V69off is higher than any of the power source voltages V69A, V69B and V69C, the auxiliary feedback voltage V42 is lower than the main feedback voltages V34 to V36 in the light emitting element ON state. Hence, for the purpose of generating the main feedback signal at the control input terminal P60, the switching circuit 47 must be set to the OFF state as shown in (a) of Table 1. Hence, the switching circuit 47 is required to be set to the OFF state in the light emitting element ON state and to the ON state in the light emitting element OFF state, whereby the switching circuit 47 cannot be omitted.

### 3. Third Embodiment

In the following description of a third embodiment, differences from the first embodiment and the second embodiment will be mainly described. Since the configurations, operations and effects other than those relating to the differences are similar to those according to the first embodiment and the second embodiment, their descriptions are omitted.

### 3.1 General Description

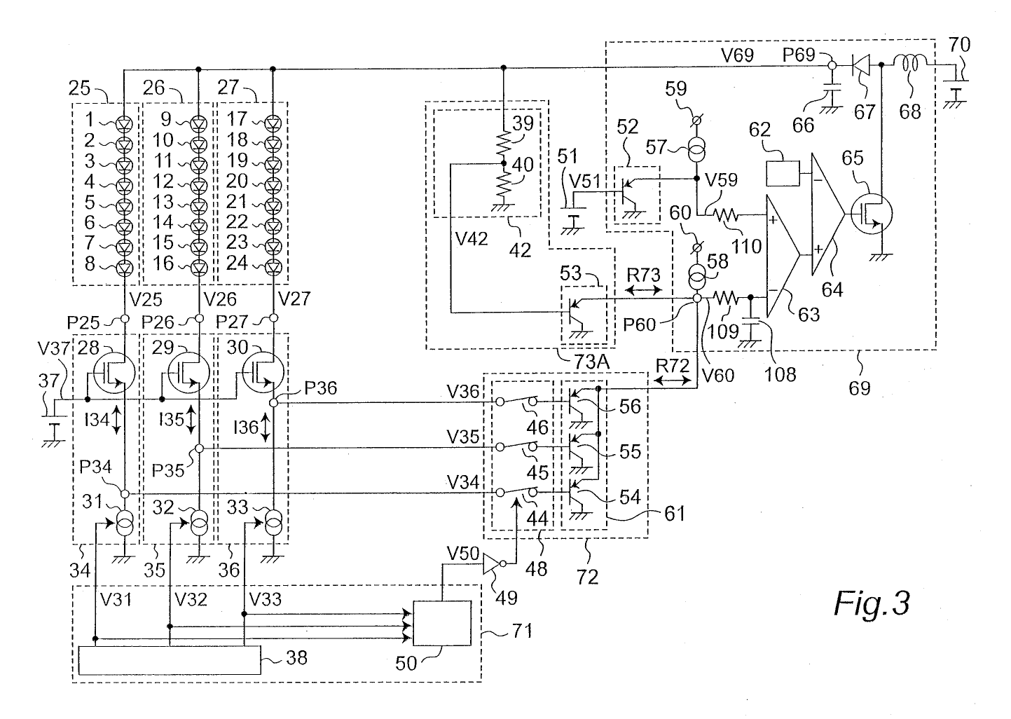

As shown in (b) of Table 1, a case in which the power source voltage V69off is not more than the highest voltage of the power source voltages V69A, V69B and V69C and not less than the lowest voltage thereof will be described below referring to FIG. 3.

FIG. 3 is a circuit diagram showing a configuration of a light emitting element driving apparatus according to the third embodiment. The configuration of the third embodiment shown in FIG. 3 is different from the configuration of the first embodiment shown in FIG. 1A in that the switching circuit 47 is omitted, that the auxiliary feedback voltage generating circuit 42 is connected to the input setting circuit 53 at all times, and that the auxiliary feedback circuit 73 is altered to an auxiliary feedback circuit 73A.

The power source voltage V69off is set so as to be not more than the highest voltage of the power source voltages V69A to V69C and not less than the lowest voltage thereof by adjusting the resistances R39 and R40 using Expression 11. The auxiliary feedback voltage generating circuit 42 is connected to the input setting circuit 53 at all times. In this case, the main feedback voltage corresponding to the highest voltage of the power source voltages V69A to V69C is the lowest voltage of the main feedback voltages V34 to V36. On the other hand, the main feedback voltage corresponding to the lowest voltage of the power source voltages V69A to V69C is the highest voltage of the main feedback voltages V34 to V36. For this reason, the auxiliary feedback voltage V42 is set so as to be not less than the lowest voltage of the main feedback voltages V34 to V36 and not more than the highest voltage thereof.

### 3.2 Light Emitting Element OFF State

First, in the light emitting element OFF state, as described above in (d) of Table 1, the auxiliary feedback signal is generated at the control input terminal P60, and the light emitting element driving apparatus operates as in the case of the first embodiment.

### 3.3 Light Emitting Element ON State

Next, in the light emitting element ON state, the operation of the light emitting element driving apparatus is described in two separate cases, that is, a case in which the number of the current driving circuits 34 to 36 being in the ON state is three and a case in which the number of the current driving circuits 34 to 36 being in the ON state is one or two.

Firstly in the case in which the number of the current driving circuits being in the ON state is three, since voltages higher than the power source voltage V69off exist surely in the power source voltages V69A to V69C, voltages lower than the auxiliary feedback voltage V42 also exist surely in the main feedback voltages V34 to V36. Hence, the main feedback signal corresponding to the lowest main feedback voltage is generated at the control input terminal P60, and the third embodiment operates similar to the first embodiment.

Secondly, the case in which the number of the current driving circuits being in the ON state is two or one is further separated into two cases, that is, a case in which the lowest voltage of the auxiliary feedback voltage V42 and one or two main feedback voltages corresponding to the ON state is the auxiliary feedback voltage V42 and a case in which the lowest voltage is one of the main feedback voltages (or the one main feedback voltage). In the case in which the lowest voltage is the auxiliary feedback voltage V42, the auxiliary feedback signal is generated at the control input terminal P60, and in the case in which the lowest voltage is one of the main feedback voltages (or the one main feedback voltage), the main feedback signal is generated at the control input terminal P60. Hence, when the power source voltage V69on is adjusted using the power source circuit 69, voltages of the main feedback voltages V34 to V36, higher than the auxiliary feedback voltage V42, are ignored, whereby voltages of the power source voltages V69A to V69C, lower than the power source voltage V69off, are ignored. As a result, the variations in the power source voltage V69on can be reduced.

In the case that at least either the variations in the voltages across the terminals of the light emitting element groups 25 to 27 or the variations in the ON voltages of the N-channel MOS transistors 28 to 30 are large, the differences among the power source voltages V69A to V69C represented by Expression 4 become larger, and the differences among the main feedback voltages V34 to V36 represented by Expression 8 also become larger. In this case, when a state in which some of the current driving circuits 34 to 36, being in the ON state, is switched to a state in which other circuits thereof are set to the ON state, the power source voltage V69on fluctuates significantly. In particular, in the case that the number of the current driving circuits to be set to the ON state is one, the effect of the variations is directly reflected, and the fluctuations in the power source voltage V69on1 become large. For example, when a state in which only the current driving circuit 34 is in the ON state is switched to a state in which only the current driving circuit 36 is set to the ON state according to Expression 4, the power source voltage V69on1 lowers significantly from V69A to V69C. As a result, the power loss in the current driving circuit 36 increases. Conversely, when a state in which only the current driving circuit 36 is in the ON state is switched to a state in which only the current driving circuit 34 is set to the ON state, the power source voltage V69on1 rises significantly from V69C to V69A. As a result, the responsiveness of the current driving circuit 34 becomes low.

### 3.4 Summary

However, with the configuration of the third embodiment, when a state in which some of the current driving circuits 34 to 36, being in the ON state, is switched to a state in which other circuits thereof are set to the ON state, the variations in the power source voltage V69on can be reduced by setting the power source voltage V69off so as to be not more than the highest voltage of the power source voltages V69A to V69C and not less than the lowest voltage thereof and by connecting the auxiliary feedback voltage generating circuit 42 to the input setting circuit 53 at all times. Hence, it is possible to improve the responsiveness of the current driving circuits when the circuits are switched to operate on higher voltages and to improve the power loss in the current driving circuits when the circuits are switched to operate on lower voltages.

Furthermore, the power source voltage V69off may be set so as to be not more than but close to the highest voltage of the power source voltages V69A to V69C. In this case, the auxiliary feedback voltage V42 becomes a voltage not less than but close to the lowest voltage of the power source voltages V69A to V69C. Hence, the fluctuations in the power source voltage V69on are limited to have values close to the highest voltage of the power source voltages V69A to V69C.

### 4. Fourth Embodiment

In the following description of a fourth embodiment, differences from the first embodiment will be mainly described. Since the configurations, operations and effects other than those relating to the differences are similar to those according to the first embodiment, their descriptions are omitted.

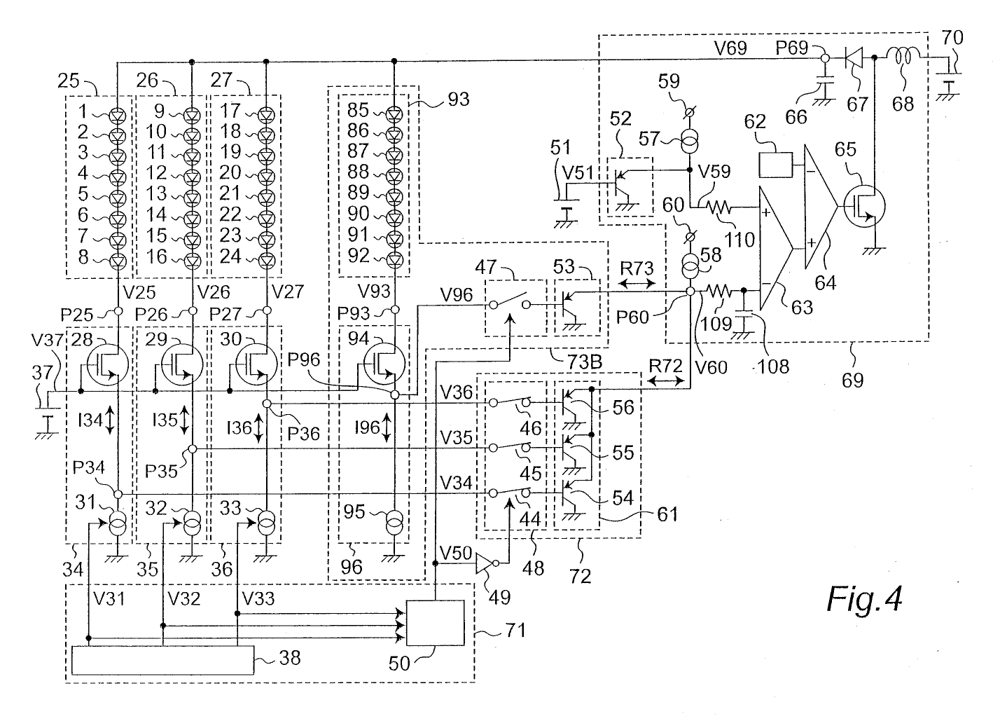

FIG. 4 is a circuit diagram showing a configuration of a light emitting element driving apparatus according to the fourth embodiment. The configuration of the fourth embodiment shown in FIG. 4 is different from the configuration of the first embodiment shown in FIG. 1A in that the auxiliary feedback circuit 73 and the auxiliary feedback voltage generating circuit 42 contained in the auxiliary feedback circuit 73 are altered to an auxiliary feedback circuit 73B and a dummy light emitting element group 93 and a dummy current driving circuit 96 contained in the auxiliary feedback circuit 73B, respectively.

The dummy light emitting element group 93 contains a dummy light emitting element 85, a dummy light emitting element 86, a dummy light emitting element 87, a dummy light emitting element 88, a dummy light emitting element 89, a dummy light emitting element 90, a dummy light emitting element 91, and a dummy light emitting element 92. The dummy current driving circuit 96 contains a dummy N-channel MOS transistor 94 and a dummy current source 95.

One terminal of the dummy light emitting element group 93 is connected to the power source voltage output terminal P69, and the other terminal thereof is connected to one terminal of the dummy current driving circuit 96 via a dummy load connection terminal P93. Like the light emitting elements 1 to 24, the dummy light emitting elements 85 to 92 are formed of dummy LEDs, for example. In the dummy light emitting element group 93, all the dummy LEDs 85 to 92 are connected in series in the forward direction from one terminal of the dummy light emitting element group 93 to the other terminal thereof. The other terminal of the dummy current driving circuit 96 is grounded.

In the dummy current driving circuit 96, the drain of the dummy N-channel MOS transistor 94 is connected to one terminal of the dummy current driving circuit 96, the source thereof is connected to one terminal of the dummy current source 95 via a dummy feedback output terminal P96, and the gain thereof is connected to the voltage source 37. The other terminal of the dummy current source 95 is connected to the other terminal of the dummy current driving circuit 96, and the control terminal of the dummy current source 95 is connected to a predetermined voltage source. Like the current sources 31 to 33, the dummy current source 95 is formed of an N-channel MOS transistor.

The power source circuit 69 supplies the power source voltage V69 to the dummy light emitting element group 93. The dummy current driving circuit 96 generates a dummy drive current I96 for driving the dummy light emitting element group 93 and also generates a dummy auxiliary feedback voltage V96 at the dummy feedback output terminal P96. Since the dummy drive current I96 flows through the dummy light emitting element group 96, a dummy load voltage V93 obtained by subtracting the voltage across the terminals of the dummy light emitting element group 93 from the power source voltage V69 appears at the dummy load connection terminal P93. From a different point of view, the power source circuit 69 supplies the power source voltage V69 to the series circuit of the dummy light emitting element group 93 and the dummy current driving circuit 96, whereby the dummy load voltage V93 is generated at the dummy load connection terminal P93, and the dummy auxiliary feedback voltage V96 is generated at the dummy feedback output terminal P96. The dummy current source 95 passes the dummy drive current I96 through the series circuit of the dummy light emitting element group 93 and the dummy current driving circuit 96.

The dummy current source 95 is set to the ON state at all times using the predetermined voltage source, and the dummy drive current I96 is in the ON state at all times. The power source voltage V69 supplied to the auxiliary feedback circuit 73B can be adjusted by setting the output voltage of the predetermined voltage source to a desired voltage. Since the dummy light emitting element group 93 is configured so as to be physically similar to the light emitting element groups 25 to 27, the group has operating characteristics substantially equal to those of the light emitting element groups 25 to 27. Furthermore, since the dummy current driving circuit 96 is configured so as to be physically similar to the current driving circuits 34 to 36, the circuit has operating characteristics substantially equal to those of the current driving circuits 34 to 36. Hence, the dummy drive current I96 is substantially equal to the drive currents I34 to I36 being in the ON state, the dummy load voltage V93 is substantially equal to the load voltages V25 to V27 being in the ON state, and the dummy auxiliary feedback voltage V96 is substantially equal to the main feedback voltages V34 to V36 being in the ON state.

A route from the power source voltage output terminal P69 to the control input terminal P60 via the dummy light emitting element group 93, the dummy load connection terminal P93, the dummy current driving circuit 96, the dummy feedback output terminal P96, the switching circuit 47 and the input setting circuit 53 inside the auxiliary feedback circuit 73B is referred to as an auxiliary route R73.

As described above, the auxiliary feedback circuit 73B uses the dummy light emitting element group 93 and the dummy current driving circuit 96 configured similar to the light emitting element groups 25 to 27 and to the current driving circuits 34 to 36, respectively. Hence, voltage drop fluctuations due to temperature changes and fluctuations due to variations in the dummy light emitting element group 93 and the current driving circuits 34 to 36 are substantially equal to the fluctuations in the light emitting element groups 25 to 27 and the current driving circuits 34 to 36. Therefore, when temperature changes and variations occur, the dummy auxiliary feedback voltage V96 fluctuates similarly to the main feedback voltages V34 to V36, and the power source voltage V69off based on the dummy auxiliary feedback voltage V96 also fluctuates similar to the power source voltage V69on based on the main feedback voltages V34 to V36. As a result, in the presence of fluctuations due to temperature changes and fluctuations due to variations, the difference between the dummy auxiliary feedback voltage V96 and the main feedback voltages V34 to V36 becomes small, whereby the difference between the power source voltage V69off and the power source voltage V69on becomes small. For this reason, the responsiveness and power loss in the current driving circuits 34 to 36 can be improved further.

Although the dummy light emitting element group 93 is used to set the power source voltage V69off in the auxiliary feedback circuit 73B, the group may also be used as a light emitting apparatus for other applications.

Furthermore, in the auxiliary feedback circuit 73B, the ON/OFF state switching function using the current source 95 may also be used instead of the ON/OFF state switching function using the switching circuit 47.

### 5. Fifth Embodiment

In the following description of a fifth embodiment, differences from the first embodiment will be mainly described. Since the configurations, operations and effects other than those relating to the differences are similar to those according to the first embodiment, their descriptions are omitted.

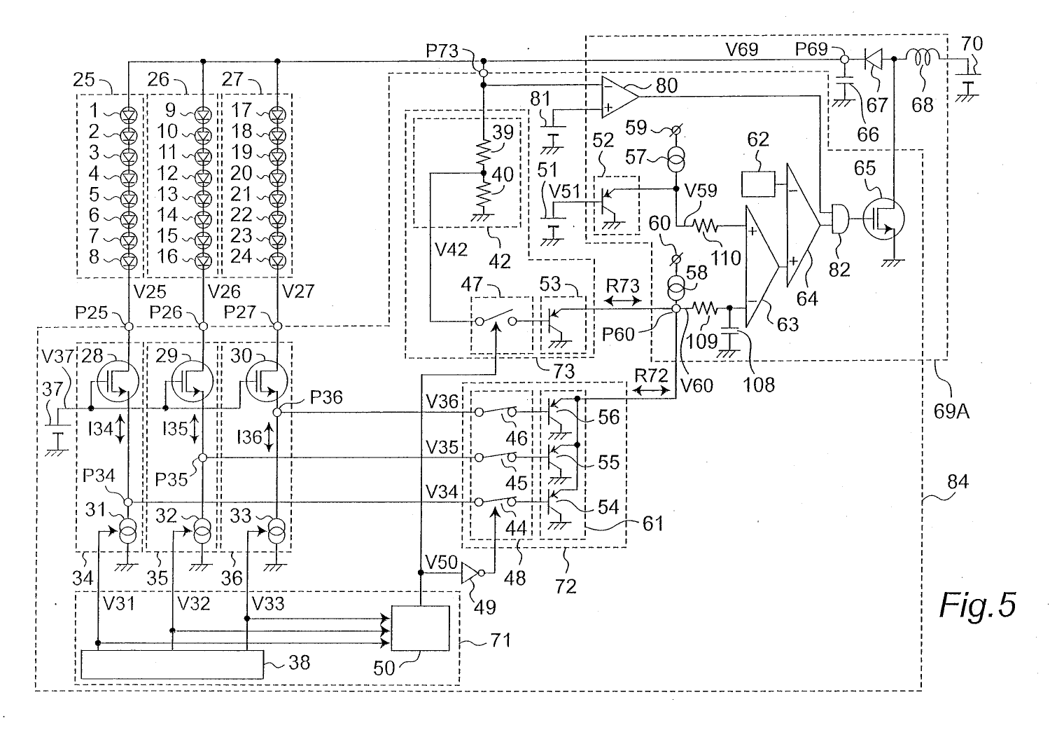

FIG. 5 is a circuit diagram showing a configuration of a light emitting element driving apparatus according to the fifth embodiment. In comparison with the configuration of the first embodiment shown in FIG. 1A, the configuration of the fifth embodiment shown in FIG. 5 further contains a comparator 80, a voltage source 81, an AND circuit 82, an auxiliary feedback circuit input terminal P73 and a semiconductor substrate 84. The power source circuit 69 of the first embodiment shown in FIG. 1A is altered to a power source circuit 69A, and the power source circuit 69A contains the comparator 80 and the AND circuit 82 that are two of the circuits added to the apparatus as described above.

The auxiliary feedback circuit 73 receives the power source voltage V69 via the auxiliary feedback circuit input terminal P73. The comparator 80 compares the power source voltage V69 at the auxiliary feedback circuit input terminal P73 with the predetermined voltage of the voltage source 81, and transmits a comparison result signal to the AND circuit 82. The AND circuit 82 transmits the logical AND signal of the comparison result signal and a pulse-width modulation signal generated in the pulse-width modulation circuit 64 to the gate of the switching device 65. The switching device 65 is turned ON/OFF by the logical AND signal. In the case that the power source voltage V69 is less than the predetermined voltage of the voltage source 81, the logical AND signal coincides with the pulse-width modulation signal. In the case that the power source voltage V69 is not less than the predetermined voltage of the voltage source 81, the logical AND signal become low, the pulse-width modulation signal is nullified, and the switching device 65 is turned OFF. In the case that the predetermined voltage of the voltage source 81 is set to the allowable maximum voltage of the power source voltage V69, if the power source voltage V69 becomes higher than the allowable maximum voltage, the voltage step-up operation of the power source circuit 69A can be stopped forcibly. In this sense, the circuit containing the comparator 80, the voltage source 81 and the AND circuit 82 is referred to as an overvoltage protection circuit. The AND circuit 82 is also referred to as a nullifier.

The current driving circuits 34 to 36, the control circuit 71, the main feedback circuit 72, the auxiliary feedback circuit 73, the inverter 49, the voltage sources 37, 51 and 81, and part of the power source circuit 69A are formed on the semiconductor substrate 84 serving as a single substrate. The part of the power source circuit 69A contains the current source 58, the voltage source 60, the difference circuit 63, the current source 57, the voltage source 59, the input setting circuit 52, the pulse-width modulation circuit 64, the carrier generator 62, the switching device 65, the comparator 80, the AND circuit 82, the auxiliary feedback circuit input terminal P73, and the load connection terminals P25 to P27.

The power source voltage V69 output from the power source voltage output terminal P69 disposed outside the semiconductor substrate 84 is supplied to the auxiliary feedback circuit 73 via the auxiliary feedback circuit input terminal P73 disposed on the semiconductor substrate 84. At the same time, the power source voltage V69 is supplied to the comparator 80 via the auxiliary feedback circuit input terminal P73, and the overvoltage protection circuit judges whether the voltage is not less than the allowable maximum voltage. In other words, the auxiliary feedback circuit input terminal P73 serves as a terminal through which the power source voltage V69 is input to the auxiliary feedback circuit 73 and the overvoltage protection circuit. In the case that the two circuits are configured on the semiconductor substrate 84 serving as a single substrate, the number of terminals can be reduced.

The comparator 80 may compare the auxiliary feedback voltage V42 instead of the power source voltage V69 at the auxiliary feedback circuit input terminal P73 with the predetermined voltage of the voltage source 81.

The light emitting element driving apparatus according to the present invention is useful as an LED driver IC for driving the backlight LEDs of liquid crystal display televisions, notebook computers, etc. to achieve quick responsiveness in LED drive currents, low power loss in ICs, etc.

Examples all embodying the present invention are described in the above descriptions regarding the embodiments. However, the present invention is not limited to these examples but can be applied to various examples that can be configured easily by those skilled in the art using the technology according to the present invention.

What is claimed is:

1. A light emitting element driving apparatus comprising:
N (where N is an integer of 1 or more) light emitting element groups each including one or more light emitting elements;
a power source circuit, including a control input terminal, operable to supply a power source voltage to said N light emitting element groups;
N current driving circuits, each including a feedback output terminal and operable to generate a drive current for driving one of said N light emitting element groups and to generate a main feedback voltage at said feedback output terminal based on said power source voltage, whereby said N current driving circuits generate N drive currents and N main feedback voltages;
a main feedback circuit operable to apply a main feedback signal to said control input terminal based on said N main feedback voltages; and
an auxiliary feedback circuit operable to apply an auxiliary feedback signal to said control input terminal based on said power source voltage, wherein
said power source circuit adjusts said power source voltage based on at least one of said main feedback signal and said auxiliary feedback signal.

2. The light emitting element driving apparatus according to claim 1, further comprising a control circuit operable to control one of said N current driving circuits to the ON state to turn ON said drive current and to control one of said N current driving circuits to the OFF state to turn OFF said drive current.

3. The light emitting element driving apparatus according to claim 2, wherein said power source circuit adjusts said power source voltage based on said auxiliary feedback signal in the case that all said N current driving circuits are in the OFF state.

4. The light emitting element driving apparatus according to claim 2, wherein said power source circuit adjusts said power source voltage based on said main auxiliary feedback signal in the case that at least one of said power source circuits is in the ON state.

5. The light emitting element driving apparatus according to claim 2, wherein
said control circuit generates a state signal representing that all said N current driving circuits are in the OFF state, and
said power source circuit adjusts said power source voltage based on said auxiliary feedback signal in the case that said state signal is at a first level and adjusts said power source voltage based on said main feedback signal in the case that said state signal is at a second level.

6. The light emitting element driving apparatus according to claim 5, wherein
said main feedback circuit comprises a main nullifying circuit operable to nullify said main feedback signal, and
said main nullifying circuit nullifies said main feedback signal in the case that said state signal is at the first level.

7. The light emitting element driving apparatus according to claim 5, wherein
said auxiliary feedback circuit comprises an auxiliary nullifying circuit operable to nullify said auxiliary feedback signal, and
said auxiliary nullifying circuit nullifies said auxiliary feedback signal in the case that said state signal is at the second level.

8. The light emitting element driving apparatus according to claim 1, wherein said main feedback circuit generates said main feedback signal based on the lowest main feedback voltage of said N main feedback voltages.

9. The light emitting element driving apparatus according to claim 1, wherein said auxiliary feedback circuit comprises an auxiliary feedback voltage generating circuit operable to generate an auxiliary feedback voltage substantially proportional to said power source voltage and generates said auxiliary feedback signal based on said auxiliary feedback voltage.

10. The light emitting element driving apparatus according to claim 9, wherein said power source circuit adjusts said power source voltage based on the lowest voltage of said auxiliary feedback voltage and said N main feedback voltages.

11. The light emitting element driving apparatus according to claim 9, wherein
said control circuit comprises an auxiliary feedback voltage control circuit operable to control said auxiliary feedback voltage generating circuit, and
said auxiliary feedback voltage control circuit controls said auxiliary feedback voltage generating circuit to change said auxiliary feedback voltage.

12. The light emitting element driving apparatus according to claim 9, wherein
said auxiliary feedback voltage generating circuit includes two or more resistors, and
said two or more resistors divide said power source voltage to generate said auxiliary feedback voltage.

13. The light emitting element driving apparatus according to claim 1, wherein said power source circuit adjusts said power source voltage based on said auxiliary feedback signal so as to be lower than said power source voltage based on any of said N main feedback voltages.

14. The light emitting element driving apparatus according to claim 1, wherein said power source circuit adjusts said power source voltage based on said auxiliary feedback signal so as to be higher than said power source voltage based on any of said N main feedback voltages.

15. The light emitting element driving apparatus according to claim 1, wherein said power source circuit adjusts said power source voltage based on said auxiliary feedback signal so as to be from the lowest voltage to the highest voltage of said power source voltage based on said N main feedback voltages.

16. The light emitting element driving apparatus according to claim 1, wherein said power source circuit adjusts said power source voltage based on said auxiliary feedback signal in the case that at least one of said N current driving circuits is in the OFF state.

17. The light emitting element driving apparatus according to claim 1, wherein each of said N light emitting element groups is inserted between said power source circuit and one of said N current driving circuits.

18. The light emitting element driving apparatus according to claim 17, wherein said feedback output terminal is inserted between one of said N light emitting element groups and one of said N current driving circuits.

19. The light emitting element driving apparatus according to claim 17, wherein
said N current driving circuits each include a transistor and a current source, and
said transistor is inserted between one of said N light emitting element groups and said current source.

20. The light emitting element driving apparatus according to claim 19, wherein said feedback output terminal is inserted between said transistor and said current source.

21. The light emitting element driving apparatus according to claim 19, wherein
said transistor is an N-channel MOS transistor of which the drain is connected to one of said N light emitting element groups and the source is connected to said current source.

22. The light emitting element driving apparatus according to claim 19, wherein
said transistor is an NPN transistor of which the collector is connected to one of said N light emitting element groups and the emitter is connected to said current source.

23. The light emitting element driving apparatus according to claim 19, wherein
said current source is an N-channel MOS transistor of which the drain is connected to said transistor.

24. The light emitting element driving apparatus according to claim 19, wherein
said current source is an NPN transistor of which the collector is connected to said transistor.

25. The light emitting element driving apparatus according to claim 1, wherein
said power source circuit comprises:
a difference circuit operable to generate a difference signal representing the difference between a predetermined value and a value of one of said main feedback signal and said auxiliary feedback signal at said control input terminal,
a carrier generator operable to generate a desired carrier signal,
a pulse-width modulation circuit operable to generate a pulse-width modulation signal representing the result of the comparison between said difference signal and said carrier signal,
a switching device being turned ON/OFF by said pulse-width modulation signal,
an inductor being charged and discharged with a power from a DC power source depending on the ON operation and the OFF operation of said switching device,
a diode operable to pass the discharged power in the forward direction, and
a capacitor being charged with the passed power, and
generates said power source voltage between both terminals of said capacitor.

26. The light emitting element driving apparatus according to claim 25, wherein
said power source circuit comprises:
a comparator operable to compare said power source voltage with a predetermined voltage, and
a nullifier operable to nullify said pulse-width modulation signal when said power source voltage becomes higher than said predetermined voltage.

27. The light emitting element driving apparatus according to claim 26, further comprising a power source voltage input terminal, formed on a semiconductor substrate and operable to receive said power source voltage, wherein
said auxiliary feedback circuit is formed on said semiconductor substrate and receives said power source voltage via said power source voltage input terminal,
said difference circuit, said carrier generator, said pulse-width modulation circuit, said switching device, said comparator and said nullifier, included in said power source circuit, are formed on said semiconductor substrate, and
said comparator receives said power source voltage via said power source voltage input terminal.

28. The light emitting element driving apparatus according to claim 25, wherein said power source circuit includes a filter operable to reduce the degree of variations in one of said main feedback signal and said auxiliary feedback signal.

29. The light emitting element driving apparatus according to claim 1, wherein said auxiliary feedback circuit comprises:
a dummy light emitting element group including one or more dummy light emitting elements, and
a dummy current driving circuit, including a dummy feedback output terminal, operable to generate a dummy drive current for driving said dummy light emitting element group and to generate a dummy auxiliary feedback voltage at said dummy feedback output terminal based on said power source voltage, and
applies said auxiliary feedback signal to said control input terminal based on said dummy auxiliary feedback voltage.

30. A light emitting element driving apparatus comprising:
N (where N is an integer of 1 or more) light emitting element groups each including one or more light emitting elements;
a power source circuit, including a control input terminal, operable to supply a power source voltage to said N light emitting element groups;
N current driving circuits, each including a feedback output terminal and operable to generate a drive current for driving one of said N light emitting element groups and to generate a feedback voltage at said feedback output terminal based on said power source voltage, whereby said N current driving circuits generate N feedback voltages; and
a feedback circuit operable to apply a feedback signal to said control input terminal based on said N feedback voltages, wherein
said N current driving circuits each include a transistor and a current source,
said feedback output terminal is inserted between said transistor and said current source, and
said power source circuit adjusts said power source voltage based on said feedback signal.
